(19) United States
(12) Patent Application Publication
(10) Pub. No.: US 2004/0126484 A1
(43) Pub. Date: Jul. 1, 2004

(54) Method for forming ceramic film capacitors

(76) Inventors: Robert Croswell, Hanover Park, IL (US); Jovica Savic, Downers Grove, IL (US); Aroon Tungare, Winfield, IL (US); Taeyun Kim, Cary, NC (US); Angus Ian Kingon, Cary, NC (US); Jon-Paul Maria, Raleigh, NC (US)

Correspondence Address: LARSON + ASSOCIATES PC, 221 EAST CHURCH ST., FREDERICK, MD, 21701, US

(21) Appl. No.: 10/331,693

(22) Filed: Dec. 30, 2002

(51) Int. Cl. B05D 3/02; B05D 5/12

(52) U.S. Cl. 427/79; 427/376.1

(57) ABSTRACT

Thin film ceramic foil capacitors are mass-produced using inline reel-to-reel processing techniques by starting (100) with a length of copper foil which serves as one plate of the capacitor, then depositing (120) a layer of a ceramic precursor on a portion of one side of the copper foil at a first station. The foil is advanced (117, 127, 137, 147) to the next station where the ceramic precursor and the copper foil are heated (130) to remove any carrier solvents or vehicles, then pyrolyzed (140) to remove any residual organic materials. It is then sintered (150) at high temperatures to convert the ceramic to polycrystalline ceramic. A final top metal layer is then deposited (160) on the polycrystalline ceramic to form the other plate of the capacitor. The entire process or portions of the process is performed in-line such that one or more of the steps are simultaneously performed on different portions of the foil at the same time, or such that, after any one step, the foil is advanced and the step repeated at a new location on the foil.

### CROSS REFERENCE TO RELATED APPLICATION

The present application is related to U.S. application Ser. No. 09/629504, filed Jul. 31, 2000, entitled Multi-Layer Conductor Dielectric Oxide Structure. It is also related to U.S. application Ser. No. 10/139,454, filed May 6, 2002, entitled Methods of Controlling Oxygen Partial Pressure During Annealing of a Perovskite Dielectric Layer, and Structures Fabricated Thereby.

### FIELD OF THE INVENTION

The present invention generally relates to in-line methods of creating ceramic dielectric film capacitors on copper foils.

### BACKGROUND OF THE INVENTION

The capacitor (a dielectric material sandwiched between two conductors) represents one electronic component that has substantially shrunk in recent history. However, current practice relies on individually mounting and soldering each capacitor onto the surface of circuit boards. For example, a typical cellular telephone contains over 200 surface mounted capacitors connected to a printed circuit board (PCB) by over 400 solder joints. The ability to integrate or embed capacitors in circuit boards during manufacture of the circuit boards would provide substantial space and cost savings over surface mounted capacitors, and many have endeavored to do this. Recent prior art has proposed forming ceramic films on a free-standing metal foil to be later embedded into the PCB. Ceramic dielectric films are commonly formed by a broad range of deposition techniques, such as chemical solution deposition (CSD), evaporation, sputtering, physical vapor deposition and chemical vapor deposition. However, in order to achieve the requisite dielectric structure, each technique typically requires either a high-temperature deposition or a high-temperature anneal. Organic laminates themselves cannot survive these high processing temperatures, a fact which motivates a foil-based deposition and anneal process, the resulting foil then being laminated into an organic substrate. Moreover, since common conductors such as copper readily oxidize at these high temperatures, noble metal films are required, and obviously, replacing conventional capacitors with ones that utilize more expensive materials is not the optimum solution. Others have attempted to obviate the need for noble metal films, but the creation of these capacitors needs to be further cost-reduced to bring the cost of these new capacitors down to a level that is competitive with the conventional practice of soldering discrete components to a printed circuit board. It would be a significant contribution to the art if a mass production technique for producing ceramic capacitors on inexpensive metal foil could be found.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a flow chart depicting the various processing steps of an inline process consistent with certain embodiments of the present invention.

FIGS. 2-5 are schematics of various embodiments of an inline process in accordance with the present invention.

### DETAILED DESCRIPTION OF THE INVENTION

While the invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding elements in the several views of the drawings.

Thin film ceramic foil capacitors can be economically mass-produced using inline reel-to-reel processing techniques by starting with a length of copper foil which serves as one plate of the capacitor, then depositing a layer of a ceramic precursor on a portion of one side of the copper foil at a first station. The foil is advanced to the next station where the ceramic precursor and the copper foil are heated to remove any carrier solvents or vehicles, then pyrolyzed to remove any residual organic materials. It is then sintered at high temperatures to convert the ceramic to polycrystalline ceramic. A final top metal layer is then deposited on the polycrystalline ceramic to form the other plate of the capacitor. The entire process or portions of the process is performed in-line such that one or more of the steps are simultaneously performed on different portions of the foil at the same time, or such that, after any one step, the foil is advanced and the step repeated at a new location on the foil.

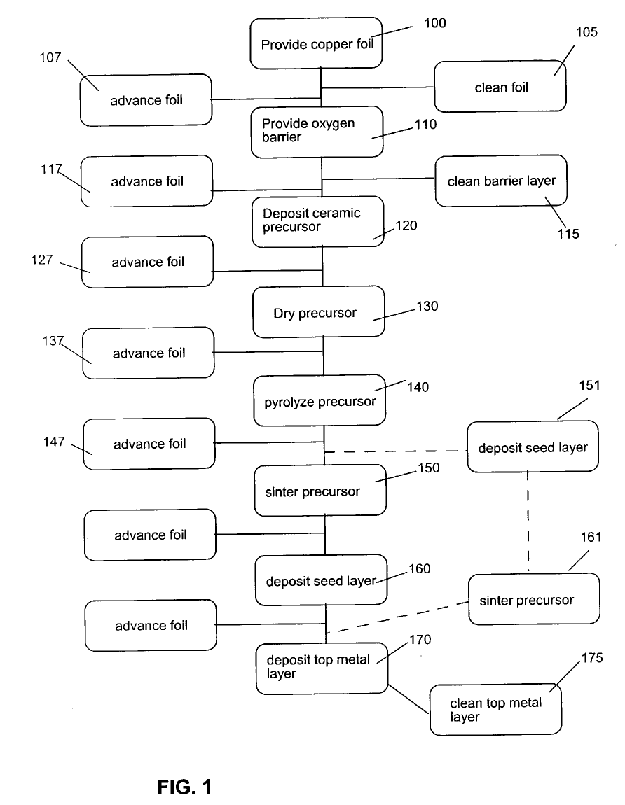

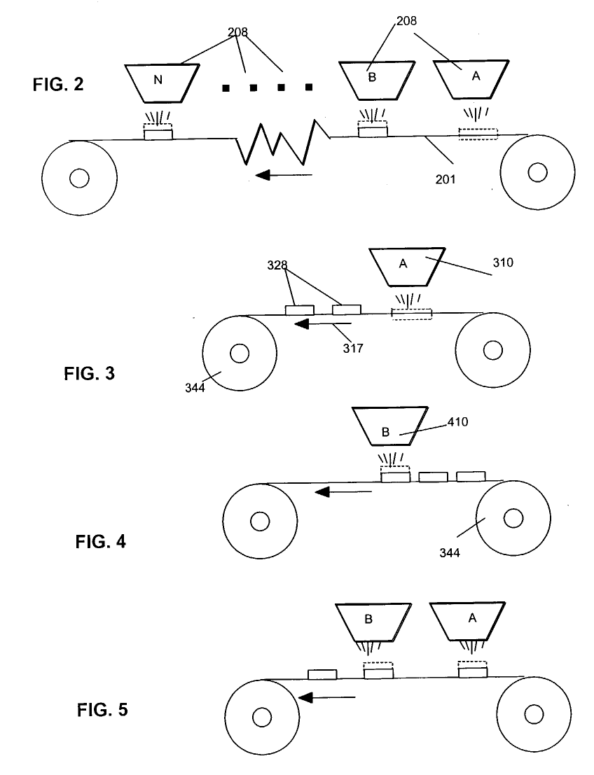

Referring now to FIG. 1, a process flow diagram of the various steps involved in one embodiment of an inline process for creating thin film parallel plate capacitors is depicted. We begin with a roll or reel of copper foil 100 that is at least 100 times as long as it is wide. Those skilled in the art will appreciate that typical inline processes utilize a long ribbon of material that is typically wound up on a reel or roll, much like a movie or a roll of masking tape, then slowly unwound into various stations where operations on the foil take place, then the processed foil is wound up again on a take-up spool or reel. We envision that a number of steps 208 could be performed on the copper foil 201 as it is unreeled and then reeled up again, as shown in FIG. 2. Alternatively, one could simply perform a single step “A” 310 on the foil as shown in FIG. 3, advance the foil a bit 317, then repeat the step again on another portion of the foil, then advance again, repeating and repeating until a plurality of locations 328 on the foil have been processed, all the while taking the foil up on a take-up reel 344 at the other end. Then that reel 344 is transferred to a new process line in FIG. 4 where a second process “B” 410 is performed on each of the previously processed sites 317 in the same manner as in FIG. 3. Or, one could use a combination as shown in FIG. 5 where two different steps “A” and “B” are preformed on the foil before it is spooled up. It should be obvious to one of ordinary skill in the art that, depending on the process conditions and equipment at hand and the wishes of the designer, one can employ a variety of combinations of single steps, multiple steps, batching, batch/inline, etc.

Having now explained the inline process, we now describe specifics of each process step and the entire process. The copper foil is generally between 5 microns and 70 microns in thickness, with 12 microns being preferred. It is important that the foil be smooth and free of defects in order to ensure that the highest possible yield of capacitors is achieved. This thin foil serves as one plate of the parallel plate capacitor. In an optional step 105 the copper foil is conditioned or cleaned and dried to prepare the surface for subsequent deposition steps, in order to ensure a good bond between layers. Cleaning the copper is achieved by conventional means such as rinsing with acetone, alcohol, chlorinated or fluorinated solvents and drying. Ultrasonic agitation can also be used. Since smoothness of the foil is a critical parameter in providing defect-free structures that have minimum leakage current and high breakdown voltage, we find that chemically polishing or electropolishing the foil surface aids in creating a higher quality capacitor.

Referring back to FIG. 1, the foil is advanced 107 and an oxygen barrier layer is deposited on the copper foil in the next step 110. The barrier layer is deposited on the conductive metal foil by sputtering, electroless plating or electrolytic plating metals selected from palladium, platinum, iridium, ruthenium oxide, nickel-phosphorus nickel-chromium or nickel-chromium with a minor amount of aluminum. More specific examples of barrier metals include electroless nickel phosphorous or electrolytic nickel. Nickel phosphorus provides a particularly effective barrier. The phosphorous content of the nickel-phosphorous generally range from about 1 to about 40 wt % phosphorous, more specifically about 4-11 wt % and even more specifically about 8 wt %. The nickel alloy should have a concentration of alloy ingredient effective to limit oxidation of the conductive metal layer. We find that nickel phosphorus barriers with about 4-11 wt % phosphorus concentration that are about 1-5 microns thick are effective Alternatively, one can begin by providing a copper foil that already has the nickel barrier layer on it, such as a Cu/NiP foil sold under the name Ohmega-Ply by Ohmega Technologies. The oxygen barrier layer keeps the copper from oxidizing and degrading during subsequent high temperature processing steps.

In another optional step 115 the barrier layer on the copper foil is cleaned and dried to remove any contaminants. Cleaning is achieved by conventional means such as rinsing with acetone, alcohol, chlorinated or fluorinated solvents and drying. Ultrasonic agitation can be used, and we also find that aqueous treatment with a suitable cleaner and rinsing is an effective method of cleaning. At this point, we believe that a breakpoint in the inline process is logical, that is, one would reel up the copper foil and transfer the reel to a processing line to deposit and treat the ceramic dielectric and continue the steps. However, as outlined above, one can break the inline process at many points or continue the entire process in one large line.

The foil is advanced 117 and a dielectric oxide or ceramic precursor is deposited 120 on the barrier layer. Some specific examples of ceramics that are formed from the precursors include lead zirconate titanate (PZT), lead lanthanum zirconate titanate (PLZT), lead calcium zirconate titanate (PCZT) lead lanthanide titanate (PLT), lead titanate (PT), lead zirconate (PZ), lead magnesium niobate (PMN), barium titanate (BTO) and barium strontium titanate (BSTO). Dielectric oxides such as PZT, PLZT and PCZT belong to a particularly promising class of high permittivity ceramic dielectrics with the perovskite crystal structure. These dielectric oxides can be made into very thin, flexible, robust layers with very high dielectric constants. Inline processes suitable for this step include spray coating, mist coating, dip coating, meniscus coating, chemical vapor deposition, or other solution coating techniques used with slurries.

After depositing the precursor on a portion of the copper roll, the foil is then advanced 127 and the ceramic precursor is dried 130 by heating to remove any carrier solvents or vehicles. This is typically accomplished in an oven at 250-450° C. for one to five minutes. A nitrogen atmosphere is beneficial to reduce the risk that the unused side of the copper foil might oxidize. Again, one skilled in the art will understand that while the ceramic precursor slurry is being deposited on one portion of the copper foil, another upstream portion of the foil is drying a previously deposited precursor solution in the oven. Processes such as depositing and baking lend themselves particularly well to continuous inline motion, rather than a stepwise motion. The foil continues to advance 137 into the pyrolyzing step 146 where the dried ceramic precursor is heated at higher temperatures for a longer time to remove the majority of the organic binding materials in the precursor. This step is highly suitable for an oven or furnace, and typical temperatures range from 250-450° C. and from 1-15 minutes, and as above, a nitrogen atmosphere is useful to prevent oxidation of the exposed side of the copper foil. Generally, the steps of depositing the precursor 120, drying the precursor 130 and pyrolyzing the precursor 140 are repeated at least once to build up a thicker layer of ceramic. This is accomplished by either breaking the inline process after step 140 and reeling up the copper foil with the dried ceramic, then restarting the foil at the beginning of the line again to be treated a second time, or one can simply add more depositing and drying stations to the existing line. Depending on the situation and processing conditions, one may elect to lay down as few as one coat of ceramic or as many as four coats of ceramic to attain the requisite physical and electrical properties.

This leaves a dielectric oxide residue deposited on the copper foil that can now be advanced 147 again and then sintered 150 at high temperatures to convert the precursor to a complex crystal structure (i.e., perovskite) in a polycrystalline orientation. Temperatures of 500-675° C. are useful, and 550-600° C. is preferred, for 1-30 minutes, in air, but preferably in a nitrogen atmosphere. At the high temperatures needed to form the ceramic dielectric, copper can form a thin layer of copper oxide at the interface between the ceramic dielectric and the copper. This can create an interface layer which will degrade the overall device performance, thus negating any advantage gained by the use of the ceramic dielectric. Second, the reducing atmosphere favored by copper produces excessive defect concentrations and may frustrate phase formation in the dielectric oxide layer. For ceramic dielectrics, it is apparent that favorable dielectric properties are intimately linked to a complex crystal structure (i.e., perovskite) that is difficult to develop at lower temperatures. The previously deposited nickel barrier layer prevents oxidation or reduction of the copper foil at high temperatures, thus eliminating the deleterious byproducts that can alter the ceramic structure. Since little or no material outgases during the sintering step 150, on can break the process again at this point and batch sinter the entire reel in a single step, for example by placing the reel in a furnace at appropriate temperatures.

Having now formed the first plate of the capacitor and the dielectric layer of the capacitor, we now turn to inline formation of the second parallel plate. Prior to depositing the second plate, a seed layer is deposited 160 on the sintered ceramic to promote subsequent plating and to ensure adequate adhesion of the subsequent metal layer to the ceramic. This layer is selected from metals such as those previously described for the barrier layer but may also include copper. This layer is deposited on the sintered dielectric oxide layer by electroless plating, evaporation, sputtering, plasma chemical vapor deposition or vacuum plating. Finally, the top metal plate of the capacitor is added 170, preferably by electroless or electrolytic plating, or by the same methods as used for the seed layer. An optional step of post conditioning 175 cleans the exterior surfaces of the copper foil to remove any oxides or other contaminants such as copper oxide. This can be accomplished by appropriate acid treatments, followed by scrupulous rinsing. The finished capacitor is then spooled up on a take-up reel for storage or transfer to another station where the capacitors are excised from the reel to be later added to the PCB.

In summary, without intending to limit the scope of the invention, thin film ceramic foil capacitors can be economically mass-produced using inline reel-to-reel processing techniques by starting with a length of copper foil which serves as one plate of the capacitor, then depositing a layer of a ceramic precursor on a portion of, one side of the copper foil at a first station. The foil is advanced to the next station where the ceramic precursor and the copper foil are heated to remove any carrier solvents or vehicles, then pyrolyzed to remove any residual organic materials. It is then sintered at high temperatures to convert the ceramic to polycrystalline ceramic. A final top metal layer is then deposited on the polycrystalline ceramic to form the other plate of the capacitor. The entire process or portions of the process is performed in-line such that one or more of the steps are simultaneously performed on different portions of the foil at the same time, or such that, after any one step, the foil is advanced and the step repeated at a new location on the foil. Those skilled in the art will recognize that the present invention has been described in terms of exemplary embodiments based upon use of a single inline process or a combination of many multiple inline processes. While the invention has been described in conjunction with these specific embodiments, it is evident that many alternatives, modifications, permutations and variations will become apparent to those of ordinary skill in the art in light of the foregoing description. For example, instead of sintering the pyrolyzed precursor to form ceramic and then depositing a seed layer on top of the sintered dielectric, one can also deposit the seed layer prior to the step of sintering, and then perform the step of sintering after the seed layer has been deposited, as is shown in FIG. 1 by the dotted lines and boxes 151 and 161 that depict an alternate embodiment. Accordingly, it is intended that the present invention embrace all such alternatives, modifications and variations as fall within the scope of the appended claims.

What is claimed is:

1. An inline reel-to-reel process for forming capacitors, comprising the following steps in the order named:
A. providing a length of copper foil;
B. depositing an oxygen barrier layer;
C. depositing a layer of ceramic precursor on a portion of the copper foil;
D. heating the ceramic precursor to convert it to polycrystalline ceramic;
E. depositing a top metal layer on the polycrystalline ceramic to form a capacitor; and
wherein any of steps b-e are executed on one portion of the length of foil at the same time as any of steps b-e are executed on another portion of the length of foil.

2. The process as described in claim 1, further comprising a step, after step A, of cleaning the copper foil.

3. The process as described in claim I, further comprising a step of cleaning the barrier layer.

4. The process as described in claim 1, wherein the oxygen barrier layer is nickel-phosphorus, nickel, platinum or ruthenium oxide.

5. The process as described in claim 1, further comprising a step, after step C, of drying the deposited precursor.

6. The process as described in claim 5, further comprising a step, after step C, of pyrolyzing the dried precursor.

7. The process as described in claim 1, further comprising a step, after step C, of depositing a seed layer on the polycrystalline ceramic;

8. The process as described in claim 1, wherein step C is repeated one or more times prior to the occurrence of step D.

9. The process as described in claim 1, wherein the step of depositing a layer of ceramic precursor comprises spray coating, mist coating, dip coating, or meniscus coating.

10. The process as described in claim 1, wherein the precursors are chosen to produce PLZT or PCZT ceramic.

11. An inline reel-to-reel process for forming capacitors, comprising the steps of:
A. providing a length of copper foil;
B. providing an oxygen barrier layer on a portion of one side of the copper foil;
C. depositing a layer of ceramic precursor on the barrier layer;
D. drying the deposited precursor;
E. pyrolyzing the dried precursor;
F. sintering the pyrolyzed precursor to form polycrystalline ceramic;
G. depositing a seed layer on the polycrystalline ceramic;
H. depositing a top metal layer on the seed layer to form a capacitor; and
wherein any of steps B-H are executed on one portion of the length of foil at the same time as any of steps B-H are executed on another portion of the length of foil.

12. The process as described in claim 11, further comprising a step, after step A, of cleaning the copper foil.

13. The process as described in claim 11, further comprising a step, after step B, of cleaning the barrier layer.

14. The process as described in claim 11, wherein steps C-E are repeated one or more times prior to the occurrence of step F.

15. The process as described in claim 11, further comprising a step, after step H of cleaning the top metal layer.

16. The process as described in claim 11, further comprising a step, after step H, of spooling the length of foil on a reel.

17. The process as described in claim 11, wherein the oxygen barrier layer is nickel-phosphorus, nickel, platinum, or ruthenium oxide.

18. The process as described in claim 11, wherein the step of depositing a layer of ceramic precursor comprises spray coating, mist coating, dip coating, or meniscus coating.

19. The process as described in claim 11, wherein the precursors are chosen to produce PLZT or PCZT ceramic.

20. An inline reel-to-reel process for forming capacitors, comprising the steps of:
providing a length of copper foil;
depositing a ceramic precursor on a first portion of the copper foil;
advancing the foil lengthwise and depositing a ceramic precursor on a subsequent portion of the foil;
repeating the step of advancing and depositing for a plurality of times;
heating the ceramic precursor to convert it to polycrystalline ceramic; and
depositing a top metal layer on the polycrystalline ceramic to form a capacitor.

21. An inline reel-to-reel process for forming capacitors, comprising the steps of:
A. providing a length of copper foil;
B. providing an oxygen barrier layer on a portion of one side of the copper foil;
C. depositing a layer of ceramic precursor on the barrier layer;
D. drying the deposited precursor;
E. pyrolyzing the dried precursor;
F. depositing a seed layer on the pyrolyzed precursor;
G. sintering the pyrolyzed precursor to form polycrystalline ceramic;
H. depositing a top metal layer on the seed layer to form a capacitor; and
wherein any of steps B-H are executed on one portion of the length of foil at the same time as any of steps B-H are executed on another portion of the length of foil.
